(19) United States
(12) Patent Application Publication
(10) Pub. No.: US 2003/0233506 A1
(43) Pub. Date: Dec. 18, 2003

(54) Communication system for exchanging data using an additional processor

(76) Inventors: Denis Archambaud, La Colle Sur Loup (FR); Peter Schneider, Haar (DE)

Correspondence Address: LERNER AND GREENBERG, P.A., POST OFFICE BOX 2480, HOOLLYWOOD, FL, 33022-2480, US

(21) Appl. No.: 10/436,746

(22) Filed: May 13, 2003

Related U.S. Application Data
(63) Continuation of application No. PCT/DE01/04081, filed on Oct. 25, 2001.

(30) Foreign Application Priority Data
Nov. 13, 2000 (DE) 100 56 198.5

(51) Int. Cl. G06F 13/24

(52) U.S. Cl. 710/260; 710/305; 710/48

(57) ABSTRACT

For data exchange with external systems, a communication system has one or more serial interfaces that are connected to a common bus line, and additionally has a first processor that is connected to the common bus line. Data exchange is regulated by a second processor, which is connected to the common bus line. The second processor is arranged together with the first processor on one and the same chip.

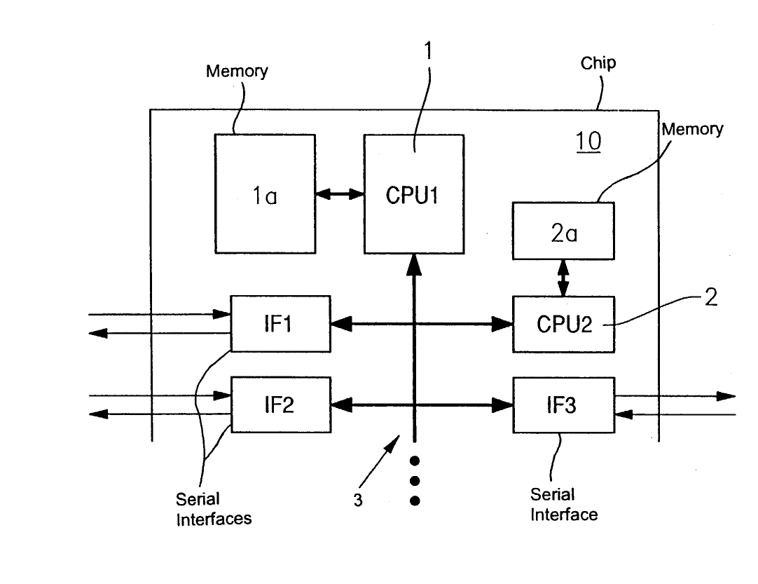

### CROSS-REFERENCE TO RELATED APPLICATIONS

This application is a continuation of copending International Application No. PCT/DE01/04081, filed Oct. 25, 2001, which designated the United States and was not published in English.

### BACKGROUND OF THE INVENTION

### FIELD OF THE INVENTION

The invention relates to a communication system for exchanging data, such as a communication system that includes a common data bus, one or more serial interfaces connected to the common bus line, and a first processor connected to the common bus line.

To transmit data from one chip to the other, communication systems having serial interfaces are normally preferred so that, for cost reasons, as few pins as possible are required on the chips that will be connected. The transmission can be organized and managed by suitable hardware elements, by software-controlled procedures or by a combination of the two. At a high data rate, it is important to find an implementation allowing the tasks arising to be suitably split between hardware and software.

A software-controlled approach to tasks has the advantage that these tasks can be matched to altered requirements easily and flexibly. The reasons for requiring matching can be, by way of example, an additionally required property, an incorrect response from the remote station or else an incorrect response from one's own station. A software-based approach generally also requires no additional chip area, with at most an increased memory requirement arising, although this normally requires less additional area than a hardware-based approach. The more that is done using software, the lower the complexity of the hardware becomes. Accordingly, the hardware becomes smaller and less susceptible to faults (faults in the hardware can often not be corrected again).

The drawback of an approach to tasks using software is that the CPU (Central Processing Unit) executing the software is burdened by this task and there is thus a smaller portion of the CPU power available for other tasks. Particularly when high data rates are transmitted via an interface and naturally when a plurality of interfaces need to be operated, this can diminish the power of the CPU to an intolerable degree, and can even make excessive demands on the CPU's performance.

As of this date, two prior art approaches to a solution have been used and they are discussed below. A common feature of the two approaches to the solution is that the serial data stream is managed solely by the hardware. In this case, it is often possible to stipulate various details of the serial data stream by providing software using configuration registers. Such a stipulation needs to be made before a transmission is started. The serial data stream covers one or more bytes.

In the first approach to a solution, the CPU is informed by an interrupt as soon as the desired number of bytes has been reached. The CPU then needs to fetch the data and to process them further. Many hardware implementations also perform simple data processing (e.g. removing a start bit and a stop bit, evaluating a parity bit) before the data are combined into bytes. The CPU has the task of sending the data to its destiny, e.g. making them available to another interface to which a display is connected, for example.

One variant of this method is using a “direct memory access” (DMA) block. A DMA autonomously (that is to say without any involvement by the CPU) transfers data from the on-chip memory to the interface or from the interface to the on-chip memory. This is initiated by the aforementioned interrupt. The purpose of this practice is to reduce the number of interrupts for the CPU by first collecting a relatively large volume of data in the on-chip memory. Nevertheless, the CPU still has the task of sending the data to its destiny.

The second approach to a solution is made possible by novel on-chip systems that permit serial interfaces to perform data transfers autonomously. This means that it is possible to perform all of the processing of the data stream using hardware, that is to say not just the serialization, but also the identification of the data's destiny and the corresponding performance of the data transfer. Drawbacks of this solution are the lack of flexibility, the difficulty in eliminating faults and the additionally required area, as mentioned above. Another drawback is that there is now direct access to memories and other on-chip peripherals. This access is directly from the outside and is not being exploited directly by the CPU.

Published European Patent Application EP 0 422 776 describes a communication system for serial data exchange which includes a microprocessor, a memory, a DMA unit and a serial interface (serial communication control, SCC). These functional blocks are connected to one another using a data bus. The document describes how the data are received by the interface and then how the address information and the message content of the data packets are written to a stipulated memory location in the memory via the data bus under the control of the DMA unit.

In this phase, the interface does not deliver any control signals to the microprocessor or to the DMA unit. The DMA unit controls the transmission of the data packets from the interface to the memory without any control over the procedure and hence without the opportunity to react to deviations from the normal procedure. Only at the end of a data packet does the DMA unit deliver a HOLD signal to the microprocessor in order to request control via the data bus as soon as the interface registers a request via a line. Since this communication system does not have a control line from the interface to the microprocessor, the serial interface cannot be operated in a conventional interrupt mode. This means that data exchange must always take place in DMA mode, in which the DMA unit controls transfer to the memory. In addition, with no control signals from the interface, the data exchange cannot be controlled accurately, which means that considerable software complexity is required for corrective measures particularly when there is a deviation from the correct procedure.

By contrast, Published German Patent Application DE 197 33 527 A1 describes a communication system in which a DMA unit has an inactive state for forwarding an interface control signal on the control line to the microprocessor. The inactive state designates an interrupt mode. The DMA unit also has an active state for forming at least one DMA control signal from the interface control signal and for delivering the formed DMA control signals on the control line to the microprocessor. The active state designates a DMA mode. In order to be able to use a serial interface for data exchange, both in the interrupt mode and in the DMA mode, the control line connecting the interface to the controlling microprocessor is connected through by the DMA unit. If the interface will be used to transmit a large volume of data, then the communication system identifies this and can activate the DMA unit, for example, under software control by the microprocessor. The DMA unit is then connected into the control line and alters the interface control signals. The control signals forwarded directly in the interrupt mode are interpreted and are assigned to DMA control signals, which are then delivered to the microprocessor instead. In the case of this solution too, the microprocessor is too highly burdened with tasks, particularly when relatively large volumes of data are being transmitted.

### SUMMARY OF THE INVENTION

It is accordingly an object of the invention to provide a communication system for exchanging data with external systems in which efficient and flexible data exchange and low burdening of the microprocessor are ensured simultaneously.

With the foregoing and other objects in view there is provided, in accordance with the invention, a communication system for exchanging data. The communication system includes: a chip; a common bus line; at least one serial interface connected to the common bus line; a first processor connected to the common bus line; and a second processor connected to the common bus line. The first processor and the second processor are configured on the chip.

In accordance with an added feature of the invention, the second processor is configured for data exchange with the serial interface; and the serial interface is configured for transmitting and/or receiving.

In accordance with an additional feature of the invention, a plurality of data lines are provided for transmitting an interrupt signal. The plurality of data lines connect the second processor to the serial interface.

In accordance with another feature of the invention, a plurality of serial interfaces are provided, and a plurality of data lines are provided for transmitting an interrupt signal. The plurality of data lines connect the second processor to the plurality of serial interfaces. The previously mentioned at least one serial interface is one of the plurality of serial interfaces.

In accordance with a further feature of the invention, a memory is configured on the chip; and the second processor is connected to the memory.

For data exchange with external systems (for example, external chips), the inventive communication system thus has a first processor and one or more serial interfaces, with the first processor and the serial interfaces being connected to a common bus line. Data exchange is organized and managed essentially by a second processor that is likewise connected to the common bus line and is arranged together with the first processor on one and the same chip.

A fundamental concept of the present invention is thus that, besides the first processor, a second processor is provided on the same chip and is essentially assigned the task of performing the data transfer from and to a serial interface—in this case particularly managing and processing interrupt tasks. Both processors can be designed in the manner of a CPU (central processing unit). In this case, it is possible, but not necessary, to choose a simpler design for the second CPU than for the first CPU, so that little chip area is required for this second CPU. In addition, in the case of this second CPU, particular importance can be placed upon a fast change of context and hence on a shorter period of time up to the processing of the interrupt task than in the case of a CPU which has not been optimized for such a task.

As in the first approach to a solution based on the prior art (as described above), hardware is used which combines the serial data stream into one or more bytes. In addition, simple processing (removing the signaling bits, etc.) is possible before the data stream is combined into bytes. At this point, however, the interrupt is signaled not to the first CPU but rather to the second CPU. This second CPU then autonomously evaluates the data from the interface and transfers the data as desired.

The advantage of this solution is that the flexibility of the software is retained (for future extensions or faults at the other end or at one's own end of the serial interface) without additionally burdening the first CPU. In comparison with the large number of interrupts in many of today's normal complex on-chip systems, the area taken up by the second CPU and by its memory is not very large and is certainly smaller than that required when the conventional second approach to a solution described above is implemented for a larger number of interrupt sources.

Another advantage is that it is a relatively simple matter to control, between two intelligent on-chip CPUs, which CPU can access which on-chip resources, for example, as between an internal CPU and an external CPU. In the case of the present invention, it is thus merely necessary to find a suitable regulation for when the first CPU and when the second CPU can access the on-chip resources.

As described above, the advantages of a hardware solution and of a software solution are combined by introducing a second CPU. This second CPU should have full control over the on-chip system so that it can autonomously relieve the load on the first CPU as best as possible.

Other features which are considered as characteristic for the invention are set forth in the appended claims.

Although the invention is illustrated and described herein as embodied in a communication system for exchanging data using an additional processor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The drawing figure shows a simple system containing three serial interfaces.

### DESCRIPTION OF THE PREFERRED EMBODIMENTS

Referring now to the drawing figure in detail, there is shown a simple system containing three serial interfaces (IF1, IF2 and IF3), a first CPU 1 (CPU1) and a second CPU 2 (CPU2), which are all arranged on a common chip 10. Both CPU1 and CPU2 can drive the on-chip bus 3 (i.e. the addresses and control signals) and thus have full control over the entire system.

The interrupt lines routed from the serial interfaces IF1, IF2 and IF3 to the second CPU 2 have been omitted in order to simplify matters. The second CPU is preferably connected to an external memory 2a arranged on the chip 10. Similarly, the first CPU 1 is connected to an external memory la in a manner which is known per se.

We claim:

1. A communication system for exchanging data, comprising:
a chip;
a common bus line;
at least one serial interface connected to said common bus line;
a first processor connected to said common bus line; and
a second processor connected to said common bus line;
said first processor and said second processor configured on said chip.

2. The communication system according to claim 1, wherein:
said second processor is configured for data exchange with said serial interface; and
said serial interface is configured for transmitting and/or receiving.

3. The communication system according to claim 2, further comprising:
a plurality of data lines for transmitting an interrupt signal;
said plurality of data lines connecting said second processor to said serial interface.

4. The communication system according to claim 2, further comprising:
a plurality of serial interfaces, said at least one serial interface being one of said plurality of serial interfaces; and
a plurality of data lines for transmitting an interrupt signal;
said plurality of data lines connecting said second processor to said plurality of serial interfaces.

5. The communication system according to claim 1, further comprising:
a memory configured on said chip;
said second processor connected to said memory.
